(19) United States
(12) Patent Application Publication
(10) Pub. No.: US 2022/0373686 A1
(43) Pub. Date: Nov. 24, 2022

(54) SCANNING SYSTEM FOR ENHANCED ANTENNA PLACEMENT IN A WIRELESS COMMUNICATION ENVIRONMENT

(71) Applicant: Metawave Corporation, Carlsbad, CA (US)

(72) Inventors: Edmond Kia Megerdichian, Vista, CA (US); Matthew Paul Harrison, Palo Alto, CA (US)

(21) Appl. No.: 17/627,106

(22) PCT Filed: Jul. 16, 2020
(86) PCT No.: PCT/US20/42417

§ 371 Date: Jan. 13, 2022

Related U.S. Application Data
(60) Provisional application No. 62/875,471, filed on Jul. 17, 2019.

(51) Int. Cl. G01S 17/89; G01S 17/86; G01S 7/481; H04W 16/18; H04W 24/02

(52) U.S. Cl. CPC G01S 17/89; G01S 17/86; G01S 7/4817; H04W 16/18; H04W 24/02

(57) ABSTRACT

Examples disclosed herein relate to a scanning system for determining enhanced placement of an antenna within an environment. The scanning system includes a sensor system configured to emit an optical signal pulse to a surrounding environment of the scanning system and receive one or more returning optical signal pulses reflected from one or more reflective objects in the surrounding environment. The sensor system obtains a plurality of sensor data slices along a first direction from the one or more returning optical signal pulses. Each of the sensor data slices corresponds to a different position of the scanning system along a second direction orthogonal to the first direction. The scanning system also includes a perception module communicably coupled to the sensor system and configured to generate mapping information of the identified one or more reflective objects in the scene with one or more trained neural networks in the perception module.

### CROSS REFERENCE TO RELATED APPLICATIONS

This application claims priority to U.S. Prov. Appl. No. 62/875,471, titled “SCANNING SYSTEM FOR ENHANCED ANTENNA PLACEMENT IN A WIRELESS COMMUNICATION ENVIRONMENT,” filed on Jul. 17, 2019, which is incorporated by reference herein in its entirety.

### BACKGROUND

New generation wireless networks are increasingly becoming a necessity to accommodate user demands. Mobile data traffic continues to grow every year, challenging the wireless networks to provide greater speed, connect more devices, have lower latency, and transmit more and more data at once. Users now expect instant wireless connectivity regardless of the environment and circumstances, whether it is in an office building, a public space, an open preserve, or a vehicle. In response to these demands, new wireless standards have been designed for deployment in the near future. A large development in wireless technology is the fifth generation of cellular communications (5G) which encompasses more than the current Long-Term Evolution (LTE) capabilities of the Fourth Generation (4G) and promises to deliver high-speed Internet via mobile, fixed wireless and so forth. The 5G standards extend operations to millimeter wave bands, which cover frequencies beyond 6 GHz, and to planned 24 GHz, 26 GHz, 28 GHz, and 39 GHz up to 300 GHz, all over the world, and enable the wide bandwidths needed for high speed data communications.

The millimeter wave (mm-wave) spectrum provides narrow wavelengths in the range of ˜1 to 10 millimeters that are susceptible to high atmospheric attenuation and have to operate at short ranges (just over a kilometer). In dense-scattering areas with street canyons and in shopping malls for example, blind spots may exist due to multipath, shadowing and geographical obstructions. In remote areas where the ranges are larger and sometimes extreme climatic conditions with heavy precipitation occur, environmental conditions may prevent operators from using large array antennas due to strong winds and storms. These and other challenges in providing millimeter wave wireless communications for 5G networks impose ambitious goals on system design, including the ability to generate desired beam forms at controlled directions while avoiding interference among the many signals and structures of the surrounding environment.

### BRIEF DESCRIPTION OF THE DRAWINGS

The present application may be more fully appreciated in connection with the following detailed description taken in conjunction with the accompanying drawings, which are not drawn to scale and in which like reference characters refer to like parts throughout, and wherein:

FIG. 1 conceptually illustrates a perspective view diagram of an example of a scanning system for surveying an environment in accordance with some implementations of the subject technology;

FIG. 2 is a schematic diagram of a scanning module in accordance with some implementations of the subject technology;

FIG. 3 illustrates a schematic diagram of a scanning system that includes an interface to a perception module in accordance with various implementations of the subject technology;

FIG. 4 illustrates a flowchart of an example process for scanning a scene in a wireless communication environment for enhanced antenna placement in the scanned environment in accordance with various implementations of the subject technology;

FIG. 5 conceptually illustrates a scanning system surveying a scene of an indoor environment in accordance with various implementations of the subject technology;

FIG. 6 conceptually illustrates an example of a reflectarray antenna with an enhanced placement in an indoor environment in accordance with various implementations of the subject technology; and

FIG. 7 conceptually illustrates an example of reflectarray antennas with an enhanced placement in an outdoor environment in accordance with various implementations of the subject technology.

### DETAILED DESCRIPTION

A scanning system and method thereof for enhanced antenna placement of meta-structure based reflectarrays are disclosed. The reflectarrays are suitable for many different 5G applications and can be deployed in a variety of environments and configurations. In various examples, the reflectarrays are arrays of cells having meta-structure reflector elements that reflect incident radio frequency (“RF”) signals in specific directions. A meta-structure, as generally defined herein, is an engineered, non- or semi-periodic structure that is spatially distributed to meet a specific phase and frequency distribution. A meta-structure reflector element is designed to be very small relative to the wavelength of the reflected RF signals. The reflectarrays can operate at the higher frequencies required for 5G and at relatively short distances. Their design and configuration are driven by geometrical and link budget considerations for a given application or deployment, whether indoors or outdoors. The placement of the reflectarrays, whether indoors or outdoors, is a key contributing factor to their performance.

The subject technology provides for a scanning system that can actively estimate distances to environmental and/or structural features while scanning through a scene to generate a cloud of point positions indicative of a multi-dimensional shape of the scene. The scanning system measures individual point positions by emitting an optical signal pulse and detecting a returning optical signal pulse reflected from an object within the scene, and then determining the distance to the reflective object based on a time delay between the emitted pulse and the reception of the reflected pulse. Unlike conventional scanning devices that include a sensor mounted on a vehicle that laterally moves along the x-axis and the sensor rotates about the y-axis for scanning a scene along a horizontal plane, the scanning system of the subject technology includes a sensor mounted on a portable platform that laterally moves along the x-axis and the sensor rotates about the x-axis for scanning a scene along a vertical plane. The sensor data is then processed by a neural network for detecting and identifying reflective objects in the scene such that optimal locations in the scene will increase the signal strength and coverage areas for wireless communication signals at millimeter wave frequencies, for example. The subject technology provides advantages over the conventional scanning systems by providing greater resolution with the combination of the scanned scene slices along the vertical plane and the multiple slices gathered along the horizontal plane over time.

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology. In other instances, well-known methods and structures may not be described in detail to avoid unnecessarily obscuring the description of the examples. Also, the examples may be used in combination with each other.

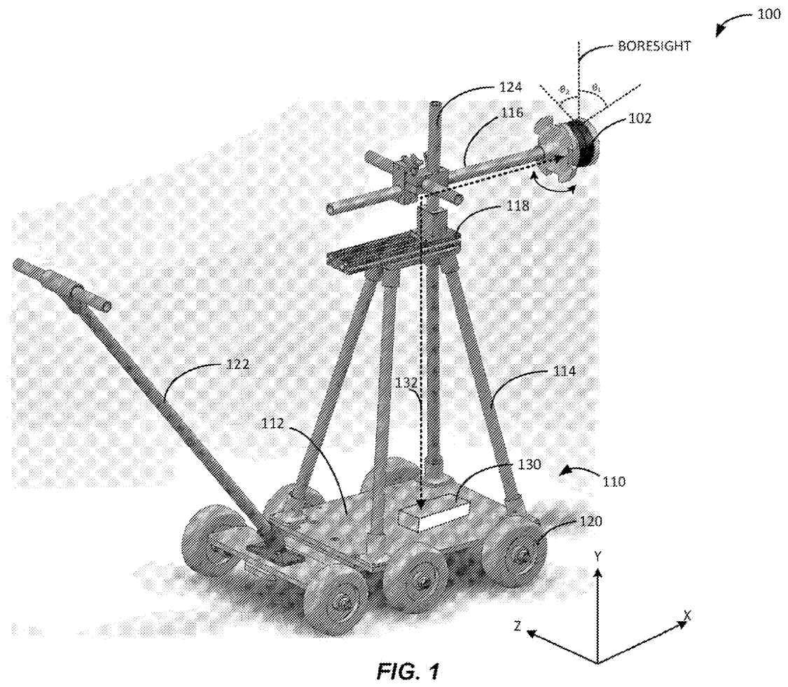

FIG. 1 conceptually illustrates a perspective view diagram of an example of a scanning system 100 for surveying an environment in accordance with some implementations of the subject technology. The scanning system 100 includes a sensor device 102 and a mobile platform 110. The mobile platform 110 includes a body 112, support legs 114, mounting arm 116, a mounting bracket 118, a set of wheels 120 and a handle 122. Not all of the depicted components may be used, however, and one or more implementations may include additional components not shown in the figure. Variations in the arrangement and type of the components may be made without departing from the scope of the claims set forth herein. Additional components, different components, or fewer components may be provided. In some implementations, the mobile platform 110 is a terrestrial vehicle. In other implementations, the mobile platform 110 may be an unmanned aerial vehicle (UAV), such as a drone. In this respect, the sensor device 102 may be mounted on a drone for capturing aerial images of a three-dimensional scene.

In some implementations, the sensor device 102 is, or includes at least a portion of, a light detection and ranging (LiDAR) device. In other implementations, the sensor device 102 is, or includes a portion of, a camera, or the like. The sensor device 102 is mechanically coupled to a first end of the mounting arm 116. The sensor device 102 rotates about the x-axis at the coupling with the mounting arm 116 such that the sensor device 102 has a range of scanning angles of a scene along the z-axis. In this respect, the sensor device 102 can emit optical signaling and detect reflected optical signaling along the z-axis within the range of scanning angles. For example, the sensor device 102 can provide a scanning field-of-view (FoV) of θ₁+θ₂ along the z-axis. In some implementations, θ₁ is equivalent to θ₂. For example, θ₁=θ₂=60° for a total FoV equivalent to 120°. In other implementations, θ₁ is different than θ₂. The values of θ₁ and θ₂ are arbitrary and can vary from the example values described herein without departing the scope of the present disclosure.

The mounting arm 116 is positioned parallel to a plane of the body 112. The mounting bracket 118 is mechanically coupled to the mounting arm 116 proximate to a second end of the mounting arm 116 through a retaining rod 124. The mounting bracket 118 includes grooves on a top surface of the mounting bracket 118. The retaining rod 124 may be laterally displaced from a stationary position along the x-axis through the grooves of the mounting bracket 118 to reconfigure the position of the sensor device 102. The mounting bracket is mechanically coupled to first ends of the support legs 114. The support legs 114 are arranged along the z-axis and converge at a bottom surface of the mounting bracket 118 such that the support legs support the mounting bracket 118 at a distance above the body 112. The body 112 is mechanically coupled to second ends of the support legs 114 at corners of the body 112 through respective ones of the support legs 114. The set of wheels 120 is coupled to each side of the body 112. The handle 122 is permanently coupled to a fixed position at an end of the body 112 with an elevated angle relative to the top surface of the body 112 in some implementations, or is non-permanently coupled to the body 112 through a hinge (not shown) such that the handle 112 can rotate within a predetermined range of movement. The scanning system 100 can be displaced laterally along the x-axis through rotation of the set of wheels 120. In some aspects, the scanning system 100 is displaced by pulling and/or pushing forces being applied to the handle 122.

The sensor device 102 can actively estimate distances to environmental and/or structural features while scanning through a scene to gather a cloud of point positions indicative of a three-dimensional (3D) shape of the scene. Individual point positions are measured by emitting an optical signal pulse and detecting a returning optical signal pulse reflected from an object within the environment with the sensor device 102, and determining the distance to the reflective object based on a time delay between the emitted pulse and the reception of the reflected pulse. The sensor device 102 may include a laser in some implementations, or a set of lasers in other implementations. The sensor device 102 can rapidly and repeatedly scan across the scene to provide continuous real-time information on distances to reflective objects in the scene.

In operation, the sensor device 102 rotates about the x-axis to emit optical pulse signaling and capture returning optical signaling along the z-axis. During the scanning, the scanning system 100 is laterally displaced along the x-axis at different times. For example, the scanning system 100 may be stationary at a first position at a first time (T₁), and laterally displaced along the x-axis from the first position to a second position at a second time (T₂). In this respect, the scanning system 100 can obtain first returning optical signaling at the first position that represents a first time slice of sensor data and second returning optical signaling at the second position that represents a second time slice of sensor data. Each of the first time slice of sensor data and the second time slice of sensor data includes detected reflective objects of a scene within the range of scanning angles along the z-axis. Although the sensor device 102 is depicted as rotating about the x-axis and capturing sensor data along the z-axis, the sensor device 102 may rotate about a different axis and capture sensor data along a different axis than the axes illustrated without departing the scope of the present disclosure.

In some implementations, the scanning system 100 includes a processing system 130 on board the body 112 of the scanning system 100. The processing system 130 may be communicably coupled to the sensor device 102 via a communication channel 132. The communication channel 132 may be wired or wireless. The processing system 130 can receive sensor data from the sensor device 102 via the communication channel 132. The processing system 130 can process the sensor data to render a multi-dimensional representation of a scanned scene and detect any reflective points (or locations) in the scanned scene. In some implementations, the processing system 130 includes one or more neural networks. In this respect, the processing system 130 can identify properties of the detected reflective objects through a trained neural network for determining behavior characteristics of the reflective objects in response to wireless communication signaling being propagated within the environment. In some implementations, the processing system 130 determines one or more control actions to be performed by the sensor device 102 based on the detection of such reflective points. For example, the one or more control actions may include signaling that causes the sensor device 102 to adjust the range of scanning angles, to adjust the number of light pulses being emitted, to adjust the intensity of the light pulses, and so forth. In some implementations, the scanning system 100 can be displaced autonomously (i.e., independent of manual user intervention with the handle 122) with autopilot instructions performed by the processing system 130. In other implementations, the processing system 130 may be communicably coupled to a radio interface such that the scanning system 100 can be displaced in response to remote control intervention by a user through wireless communication with the processing system 130.

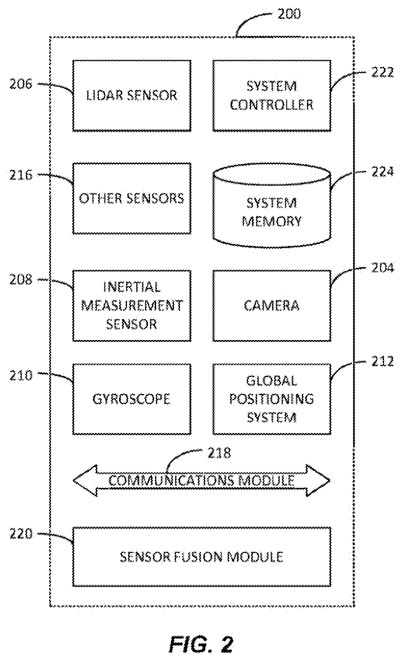

FIG. 2 is a schematic diagram of a scanning module 200 in accordance with some implementations of the subject technology. The scanning module 200 includes a LiDAR sensor 206 and other sensor systems such as a camera 204, inertial measurement sensor 208, a gyroscope 210, a global positioning system 212, and other sensors 216. The scanning module 200 also includes a communications module 218, a system controller 222, and a system memory 224. Not all of the depicted components may be used, however, and one or more implementations may include additional components not shown in the figure. Variations in the arrangement and type of the components may be made without departing from the scope of the claims set forth herein. Additional components, different components, or fewer components may be provided. It is appreciated that this configuration of the scanning module 200 is an example configuration and not meant to be limiting to the specific structure illustrated in FIG. 2.

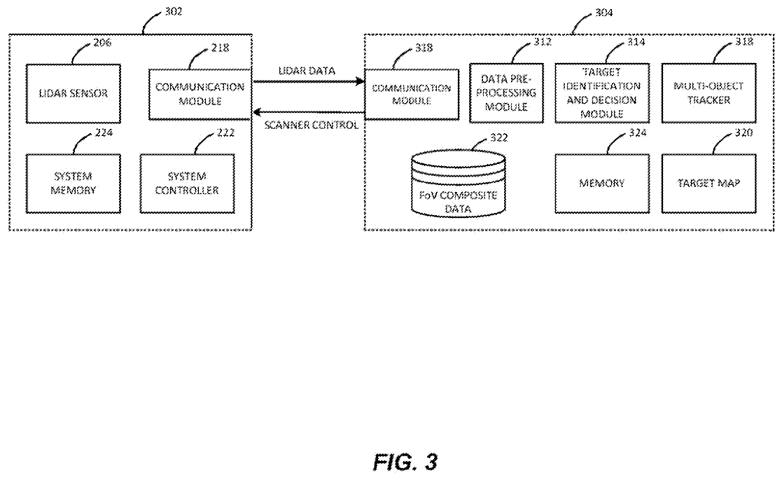

The LiDAR sensor 206 includes a laser source for emitting optical signal pulses to a scene in an environment. The emitted optical pulses are reflected from objects in the scene and received and processed by the scanning module 200 to detect and identify the reflective objects and their properties for determining enhanced antenna placement within the environment. The scanning module 200 also may include a perception module as shown in FIG. 3 that is trained to detect and identify the reflective objects in the scene and control the LiDAR sensor 206 (and/or the other sensors) as desired. The camera 204 and the other sensors 216 may also be used to detect reflective objects in the scene, albeit in a much lower resolution.

The inertial measurement sensor 208 may measure specific force, angular rate, and orientation of the LiDAR sensor 206. In some aspects, the inertial measurement sensor 208 may perform the measurements in combination with the gyroscope 210. The gyroscope 210 may measure or maintain orientation and angular velocity of the scanning module 200. The other sensors 216 may include additional sensors for monitoring conditions in and around the scanning module 200.

In some implementations, the scanning module 200 includes a sensor fusion module 220. In various examples, the sensor fusion module 220 optimizes these various functions to provide an approximately comprehensive view of the scanned scene. Many types of sensors may be controlled by the sensor fusion module 220. These sensors may coordinate with each other to share information and consider the impact of one control action on another system. In one example, in a congested scanning condition, a noise detection module (not shown) may identify that there are multiple returning optical signals that may interfere with the scanning module 200. This information may be used by a perception module in, or communicably coupled to, the scanning module 200 to adjust the emitted optical signal pulse to avoid these other returning optical signals and minimize interference.

In various examples, the sensor fusion module 220 may send a direct control signal to the LiDAR sensor 206 via the system controller 222 based on historical conditions and controls. The sensor fusion module 220 may also use some of the sensors within the scanning module 200 to act as feedback or calibration for the other sensors. In this way, the inertial measurement sensor 208 may provide feedback to the perception module and/or the sensor fusion module 220 to create templates, patterns and control scenarios. These are based on successful actions or may be based on poor results, where the sensor fusion module 220 learns from past actions.

Data from the sensors 204, 206, 208, 210 and 212 may be combined in the sensor fusion module 220 to form fused sensor data that improves the reflective object detection and identification performance of the scanning module 200. The sensor fusion module 220 may itself be controlled by the system controller 222, which may also interact with and control other modules and systems in the scanning module 200. For example, system controller 222 may turn on and off the different sensors 204, 206, 208, 210 and 212 as desired.

All modules and systems in the scanning module 200 may communicate with each other through the communication module 218. The system memory 224 may store information and data (e.g., static and dynamic data) used for operation of the scanning module 200. The data received may be processed by the sensor fusion module 220 to assist in the training and perceptual inference performance of the perception module in the scanning module 200.

FIG. 3 illustrates a schematic diagram of a scanning system 300 that includes an interface to a perception module 304 in accordance with various implementations of the subject technology. The scanning system 300 includes the scanning module 302 and a perception module 304. The scanning module 302 is, or includes at least a portion of, the scanning module 200 of FIG. 2. The scanning module 302 includes the LiDAR sensor 206, the communications module 218, the system memory 224, and the system controller 222. The perception module 304 includes a data-preprocessing module 312, a target identification and decision module 314, a multi-object tracker 318, a target map 320, a FoV composite data repository 322, and a memory 324. Not all of the depicted components may be used, however, and one or more implementations may include additional components not shown in the figure. Variations in the arrangement and type of the components may be made without departing from the scope of the claims set forth herein. Additional components, different components, or fewer components may be provided.

The optical signal pulses reflect from reflective objects in the surrounding environment, and the returning optical signal pulses are received by the scanning module 302. In some aspects, LiDAR data from the returning optical signal pulses is provided to the perception module 304 for reflective object detection and identification. The scanning module 302 sends the received LiDAR data to the data pre-processing module 312 for generating a point cloud that is then sent to the target identification and decision module 314 of the perception module 304.

The data pre-processing module 312 can process the LiDAR data to encode it into a point cloud for use by the perception module 304. In various examples, the data pre-processing module 312 can be a part of the perception module 304, such as on the same circuit board as the other modules within the perception module 304. The LiDAR data may be organized in sets of sensor data slices, corresponding to 3D information that is determined by each returning optical signal pulse reflected from reflective objects, such as elevation angles, range, reflective properties, and so forth.

The perception module 304 may control further operation of the scanning module 302 by, for example, providing a scanner control signal containing parameters for adjusting the range of scanning angles, adjusting the number of light pulses being emitted, adjusting the intensity of the light pulses, and so forth.

The system controller 222 may be responsible for directing the LiDAR sensor 306 to generate optical signal pulses with determined parameters such as beam width, transmit angle, light intensity, and so forth. The system controller 222 may, for example, determine the parameters at the direction of the perception module 304, which may at any given time determine to focus on a specific scene of the surrounding environment upon identifying reflective objects of interest in the surrounding environment. The perception module 304 may provide control actions to the LiDAR sensor 206 at the direction of the target identification and decision module 314.

The target identification and decision module 314 receives the point cloud from the data pre-processing module 312, processes the point cloud to detect and identify reflective objects in the scanned scene, and determines any control actions to be performed by the scanning module 302 based on the detection and identification of such reflective objects. For example, the scanning module 302 may scan the interior of a stadium concourse and the target identification and decision module 314 may detect columnar pillars and other structural features of the stadium concourse that may have an impact to the signal integrity and/or coverage area of a wireless network. In some implementations, the target identification and decision module 314 may direct the scanning module 302, at the instruction of its system controller 222, to focus additional optical signal pulses at a given direction and/or intensity within the portion of the scene corresponding to the location of the detected reflective object. The target identification and decision module 314 may send the scanner control signal through the communication modules 218 and 318 in real-time during the scanning operation in some implementations, or may send the scanner control signal after completion of the scanning for incorporation into a subsequent scan operation.

The multi-object tracker 318 may track the identified reflective objects over time, such as, for example, with the use of a Kalman filter. The multi-object tracker 318 may match candidate reflective objects identified by the target identification and decision module 314 with targets it has detected in previous time windows. By combining information from previous measurements, expected measurement uncertainties, and some physical knowledge, the multi-object tracker 318 can generate robust, accurate estimates of reflective object locations and/or reflective object properties.

Information on identified targets over time are then stored at a target map 320, which keeps track of locations and/or reflective properties of the reflective objects as determined by the multi-object tracker 318. The tracking information provided by the multi-object tracker 318 can be used to produce an output containing a type/class of reflective object identified, its location, its reflective properties, and so forth. This information from the scanning system 300 can be sent to a sensor fusion module (e.g., the sensor fusion module 220 in the scanning module 200), where it is processed together with information from other sensors in the scanning module 200.

In some aspects, the FoV composite data repository 322 stores information that describes an FoV. As used herein, the term “FoV” may refer to the field of view of the scanning module 302. The FoV information may be historical data used to track trends and anticipate behaviors and wireless traffic conditions or may be instantaneous or real-time data that describes the FoV at a moment in time or over a window in time. The ability to store this data enables the perception module 304 to make decisions that are strategically targeted at a particular point or area within the FoV. For example, the FoV may be clear (e.g., no echoes received) for a period of time (e.g., five minutes), and then one returning optical signal arrives from a specific region in the FoV; this is similar to detecting the front of a car. There are a variety of other uses for the FoV composite data 322, including the ability to identify a specific type of reflective object based on previous detection.

The memory 324 can store useful data for the scanning system 300, such as, for example, information on which location within the scanned scene can be used for enhanced placement of an antenna to perform better under different wireless traffic conditions. All of these detection scenarios, analysis and reactions may be stored in the perception module 304, such as in the memory 324, and used for later analysis or simplified reactions.

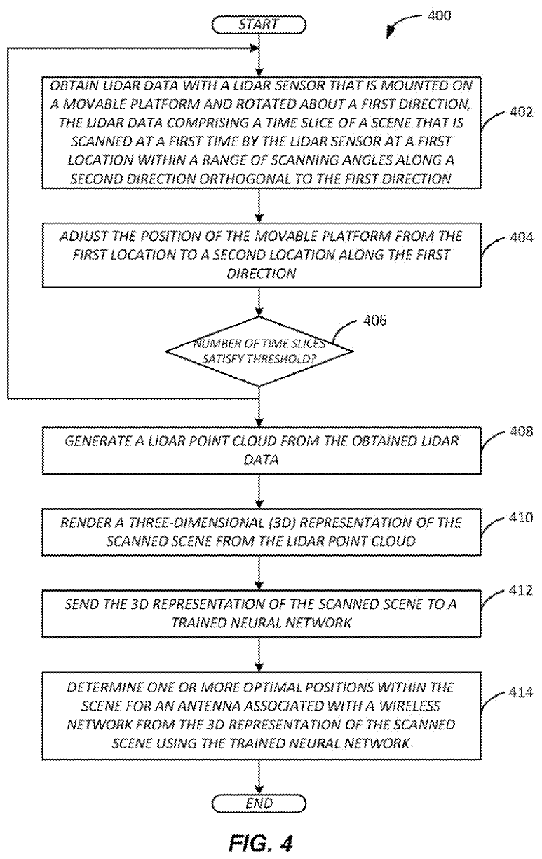

Attention is now directed to FIG. 4, which illustrates a flowchart of an example process 400 for scanning a scene in a wireless communication environment for enhanced antenna placement in the scanned environment, in accordance with various implementations of the subject technology. For explanatory purposes, the example process 400 is primarily described herein with reference to the scanning system 100 of FIG. 1; however, the example process 400 is not limited to the scanning system 100 of FIG. 1, and the example process 400 can be performed by one or more other components of the scanning system 100 of FIG. 1. Further for explanatory purposes, the blocks of the example process 400 are described herein as occurring in serial, or linearly. However, multiple blocks of the example process 400 can occur in parallel. In addition, the blocks of the example process 400 can be performed in a different order than the order shown and/or one or more of the blocks of the example process 400 are not performed.

The example process 400 begins at step 402, where LiDAR data is obtained with a LiDAR sensor (e.g., 102, 206) that is mounted on a movable platform (e.g., 110) and rotated about a first direction (e.g., x-axis). In some aspects, the LiDAR data includes a time slice of a scene in the wireless communication environment that is scanned at a first time by the LiDAR sensor at a first location within a range of scanning angles (e.g., +/−60° along a second direction orthogonal to the first direction (e.g., y-axis). Next, at step 404, the position of the movable platform is adjusted from the first location to a second location along the first direction (e.g., movement along the x-axis). Subsequently, at step 406, the scanning system (e.g., 100) determines whether the number of obtained time slices satisfies a predetermined threshold. For example, the predetermined threshold may correspond to the number of scanned slices needed to stitch (or combine) together and form the LiDAR point cloud of the scanned scene. In some examples, the number of obtained time slices exceeds the predetermined threshold to satisfy the predetermined threshold. In other examples, the number of obtained time slices is at least equivalent to the predetermined threshold for satisfying the predetermined threshold. If the number of time slices satisfies the predetermined threshold, the process 400 proceeds to step 408. Otherwise, the process 400 returns to step 402 to gather additional time slices.

Next, at step 408, the scanning system generates a LiDAR point cloud from the obtained LiDAR data. Subsequently, at step 410, the scanning system renders a 3D representation of the scanned scene from the LiDAR point cloud. Next, at step 412, the scanning system sends the 3D representation of the scanned scene to a trained neural network. In some aspects, the trained neural network is part of the scanning system. In other aspects, the trained neural network is external to the scanning system and the scanning system is communicably coupled to the trained neural network through a dedicated communication channel. Subsequently, at step 414, the scanning system determines one or more optimal positions within the scene for an antenna (e.g., reflectarray) associated with a wireless network (e.g., 5G network), from the 3D representation of the scanned scene using the trained neural network.

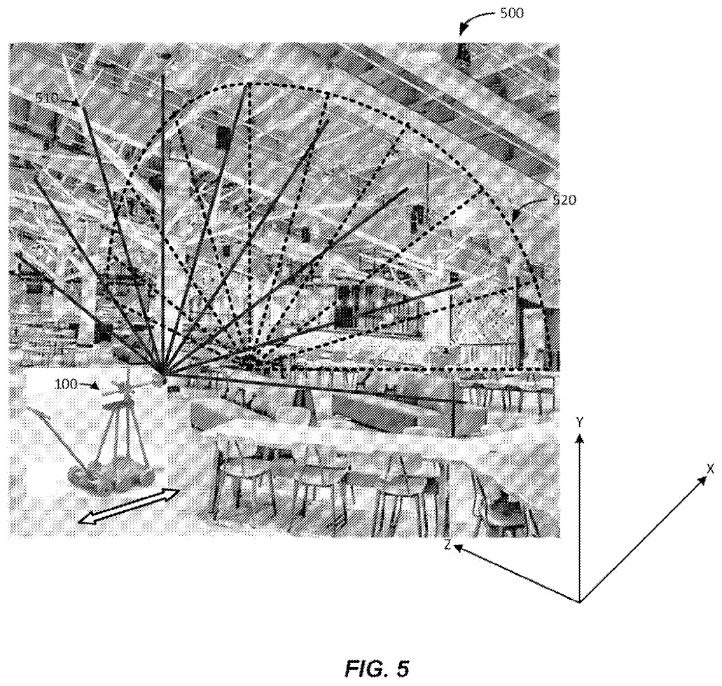

FIG. 5 conceptually illustrates a scanning system (e.g., the scanning system 100 of FIG. 1) surveying a scene of an indoor environment 500 in accordance with various implementations of the subject technology. As depicted in FIG. 5, the indoor environment 500 is a stadium concourse where reflectarray antennas may be placed (or fixed to) a structural element of the indoor environment 500 at a certain elevation to increase the coverage area of a wireless network for end users.

The scanning system can be positioned inside the indoor environment 500 for surveying the structural features and distances to such features for the enhanced placement of the reflectarray antennas. The scanning system 100 can scan through a scene of the indoor environment 500 to gather a cloud of point positions indicative of a multi-dimensional shape of the scene. The scanning system 100 can measure individual point positions by emitting an optical signal pulse and detecting a returning optical signal pulse reflected from an object within the scene, and then determining the distance to the reflective object based on a time delay between the emitted pulse and the reception of the reflected pulse.

The scanning system 100 includes a sensor device (e.g., the sensor device 102) that rotates about the x-axis to emit optical pulse signaling and capture returning optical signaling along the y-axis. During the scanning, the scanning system 100 is laterally displaced along the x-axis at different times. For example, the scanning system 100 may be stationary at a first position at a first time (T₁), and laterally displaced along the x-axis from the first position to a second position at a second time (T₂). In this respect, the scanning system 100 can receive first returning optical signaling at the first position that represents a first time slice of sensor data (e.g., 520) and receive second returning optical signaling at the second position that represents a second time slice of sensor data (e.g., 510). Each of the first time slice of sensor data 520 and the second time slice of sensor data 510 includes detected reflective objects of a scene within the range of scanning angles along the z-axis. The first time slice of sensor data 520 and the second time slice of sensor data 510 are combined (or stitched) as a function of time to form combined sensor data that includes detected reflective objects of the scene within the range of scanning angles along the z-axis at different positions along the x-axis, where each time slice corresponds to a different position along the x-axis.

By combining the measured distances and the orientation of the returning optical signal pulses when each distance is measured, a 3D position can be associated with each returning optical signal pulse. The scanning system 100 can facilitate in generating a 3D point map of detected reflective objects based on the returning pulses for an entire scanning zone. The 3D point map can indicate positions of the reflective objects in the scanned scene. In some aspects, these reflective objects may be indicative of reflective properties that may impact radiation patterns of wireless communication antennas (e.g. reflectarray antennas) installed in the indoor environment 500.

Unlike conventional scanning devices that include a sensor that rotates about the y-axis for scanning a scene along a horizontal plane, the scanning system of the subject technology includes a sensor mounted on a portable platform that laterally moves along the x-axis and the sensor rotates about the x-axis for scanning a scene along a vertical plane. The sensor data may then be processed by a neural network for detecting and identifying reflective objects in the scene such that optimal locations in the scene that increase the signal strength and coverage areas for wireless communication signals at millimeter wave frequencies, for example, can be identified. The subject technology provides advantages over the conventional scanning systems by providing greater resolution with the combination of the scanned scene slices along the vertical plane and the multiple slices that make up the horizontal plane.

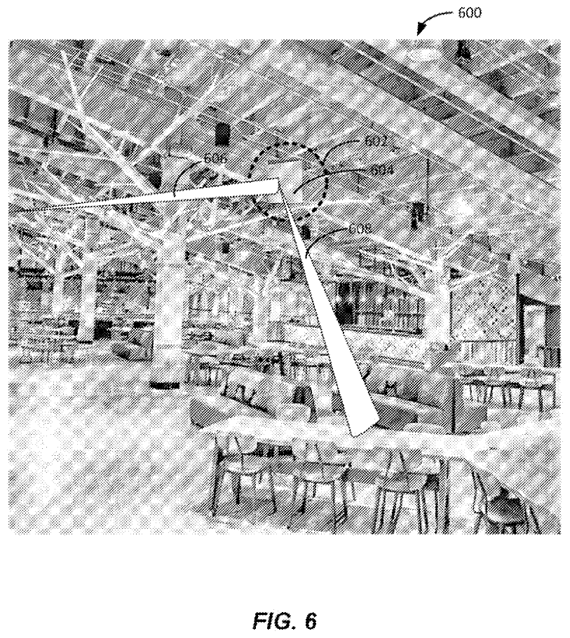

FIG. 6 conceptually illustrates an example of a reflectarray antenna 604 with an enhanced placement in an indoor environment 600 in accordance with various implementations of the subject technology. The indoor environment 600 may have a wireless radio placed in a predetermined location (not shown) for transmitting wireless communication signals to User Equipment (UE) (e.g., cellular phones). For example, the wireless radio may provide wireless network coverage to one or more UEs located within the indoor environment 600, such as within a fixed wireless network. There may be any number of UEs in indoor environment 600 at any given time with a high demand for high-speed data communications. Placement of a reflectarray antenna 604 at an enhanced location 602 that is determined through the scanning results from the scanning system (e.g., 100, 200, 302) and the perception module (e.g., 304) can enable Radio Frequency (RF) waves (e.g., 606) from the wireless radio to reach any direction with relayed RF waves 608 and provide a performance boost to the original RF signal. The performance boost achieved by the reflectarray antenna 604 may be due to the constructive effect of the directed beams reflected from all of the cells in the reflectarray antenna 604 and reflector elements in such cells. The constructive effect may be achieved with a passive (or active), low cost and easy to manufacture reflectarray that is crucial for enabling 5G applications. In addition to many configurations, the reflectarrays disclosed herein can generate narrow or broad beams as desired, e.g., narrow in azimuth and broad in elevation, at different frequencies (e.g., single, dual, multi-band or broadband), with different materials, and so forth. The reflectarrays can reach a wide range of directions and locations in any wireless network environment. The reflectarrays can be low cost, easy to manufacture and set up, and may be self-calibrated without requiring manual adjustment to its operation. In some implementations, the reflectarray antenna 604 may include a meta-structure. As used herein, term “meta-structure” refers to an engineered, non- or semi-periodic structure that is spatially distributed to meet a specific phase and frequency distribution. In some implementations, the meta-structure includes metamaterials.

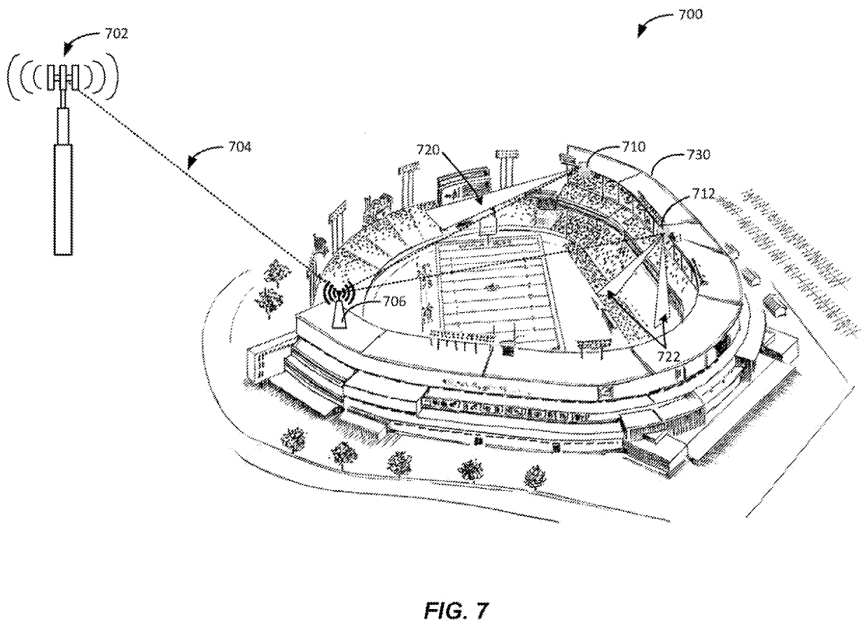

FIG. 7 conceptually illustrates an example of reflectarray antennas with an enhanced placement in an outdoor environment 700 in accordance with various implementations of the subject technology. A wireless base station (BS) 702 transmits to and receives wireless signals 704 from a wireless radio 706 that is installed on the roof of a stadium 730. The wireless radio 706 may transmit to and receive wireless signals from mobile devices within its coverage area. The coverage area may be disrupted by buildings or other structures in the outdoor environment, which may affect the quality of the wireless signals. As depicted in FIG. 7, the stadium 730 and its structural features can affect the coverage area of the BS 702 and/or the wireless radio 706 such that it has a Line-of-Sight (LOS) zone. The UEs that are outside of the LOS zone may have either no wireless access, significantly reduced coverage, or impaired coverage. Given the very high frequency bands (e.g., millimeter wave frequencies) utilized for 5G traffic, it may be difficult to expand the coverage area outside the LOS zone of the wireless radio 706.

Wireless coverage can be significantly improved to users outside of the LOS zone by the installation of reflectarray antennas on a surface of a structure (e.g., roof, wall, post, window, etc.). As depicted in FIG. 7, reflectarray antennas 710 and 712 are placed at distinct locations of the stadium 730. For example, each reflectarray antenna may be placed on a roofline edge. In this respect, a scanning system (e.g., 100, 200, 302) may have performed scanning operations to determine an enhanced placement of the reflectarray antennas 710 and 712 by detecting reflective objects of the stadium 730 and determining which locations around the stadium 730 are optimal to increase the coverage area to the UEs based at least on the scanning analysis of the detected reflective objects in the scanned scene.

Each of the reflectarray antennas 710 and 712 is a robust and low-cost passive relay antenna that is positioned at an enhanced location to significantly improve network coverage. As illustrated, each of the reflectarray antennas 710 and 712 is formed, placed, configured, embedded, or otherwise connected to a portion of the stadium 730. Although multiple reflectarrays are shown for illustration purposes, a single reflectarray may be placed in external and/or internal surfaces of the stadium 730 depending on implementation.

In some implementations, each of the reflectarray antennas 710 and 712 can serve as a passive relay between the wireless radio 706 and end users within or outside of the LOS zone. In other implementations, the reflectarray antennas 710 and 712 can serve as an active relay by providing an increase in transmission power to the reflected wireless signals. End users in a Non-Line-of-Sight (“NLOS”) zone can receive wireless signals from the wireless radio 706 that are reflected from the reflectarray antennas 710 and 712. In some aspects, the reflectarray antenna 710 may receive a single RF signal from the wireless radio 706 and redirect that signal into a focused beam 720 to a targeted location or direction. In other aspects, the reflectarray antenna 712 may receive a single RF signal from the wireless radio 706 and redirect that signal into multiple reflected signals 722 at different phases to different locations. Various configurations, shapes, and dimensions may be used to implement specific designs and meet specific constraints. The reflectarray antennas 710 and 712 can be designed to directly reflect the wireless signals from the wireless radio 706 in specific directions from any desired location in the illustrated environment.

For the UEs and others in the outdoor environment 700, the reflectarray antennas 710 and 712 can achieve a significant performance and coverage boost by reflecting RF signals from BS 702 and/or the wireless radio 706 to strategic directions. The design of the reflectarray antennas 710 and 712 and the determination of the directions that each respective reflectarray needs to reach for wireless coverage and performance improvements take into account the geometrical configurations of the outdoor environment 700 (e.g., placement of the wireless radio 706, distances relative to the reflectarray antennas 710 and 712, etc.) as well as link budget calculations from the wireless radio 706 to the reflectarray antennas 710 and 712 in the outdoor environment 700.

It is also appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. Moreover, the separation of various system components in the aspects described above should not be understood as requiring such separation in all aspects, and it should be understood that the described program components and systems can generally be integrated together in a single hardware product or packaged into multiple hardware products. Other variations are within the scope of the following claim.

What is claimed is:

1. A scanning system, comprising:
a sensor device configured to emit an optical signal pulse to a surrounding environment of the scanning system and receive one or more returning optical signal pulses reflected from one or more reflective objects in the surrounding environment, wherein the sensor device is further configured to obtain a plurality of sensor data slices along a first direction from the one or more returning optical signal pulses, wherein each of the plurality of sensor data slices corresponds to a different position of the scanning system along a second direction orthogonal to the first direction; and
a perception module communicably coupled to the sensor device and configured to generate mapping information of the one or more reflective objects in a scene with one or more trained neural networks in the perception module.

2. The scanning system of claim 1, wherein the perception module is further configured to:
determine one or more optimal locations within the scene, and
determine, based on the one or more optimal locations and the mapping information, a placement of an antenna associated with a wireless network.

3. The scanning system of claim 1, wherein the perception module is further configured to generate a cloud of point positions that is indicative of a multi-dimensional shape of the scene.

4. The scanning system of claim 3, wherein the perception module is further configured to:
measure individual point positions by emitting the optical signal pulse;
detect a returning optical signal pulse reflected from an object within the scene; and
determine a distance to the object based on a time delay between the optical signal pulse at time of emission and the returning optical signal pulse at time of reception, wherein the distance corresponds to a point position in the cloud of point positions.

5. The scanning system of claim 1, further comprising:
a mobile platform coupled to the sensor device and configured to laterally move along a first axis, wherein the sensor device is further configured to rotate about a second axis orthogonal to the first axis and scan the scene along the second axis.

6. The scanning system of claim 1, wherein the sensor device is configured to acquire a first returning optical signal pulse at a first position along the second direction that represents a first time slice of sensor data and a second returning optical signal pulse at a second position along the second direction that represents a second time slice of sensor data, wherein each of the first time slice of sensor data and the second time slice of sensor data includes detected reflective objects of the scene within a range of scanning angles along the first direction.

7. The scanning system of claim 6, wherein the perception module is configured to:
combine the first time slice of sensor data and the second time slice of sensor data as a function of time, and
generate combined sensor data that includes detected reflective objects of the scene within a range of scanning angles along the first direction at different positions of the scanning system along the second direction.

8. The scanning system of claim 1, wherein the perception module comprises:
a data pre-processing module configured to encode at least one of the plurality of sensor data slices into a point cloud for use by the perception module, wherein the at least one of the plurality of sensor data slices corresponds to three-dimensional information that is determined by each returning optical signal pulse reflected from reflective objects.

9. The scanning system of claim 8, wherein the at least one of the plurality of sensor data slices includes a time slice of the scene that is scanned at a first time within a range of scanning angles along the first direction by the sensor device at a first position along the second direction.

10. A method of scanning an environment for enhanced antenna placement in the environment, the method comprising:
obtaining, by a sensor device mounted on a mobile platform and rotates about a first direction, a plurality of sensor data slices over time along a second direction orthogonal to the first direction;
determining, by a perception module, whether the plurality of sensor data slices satisfies a predetermined threshold;
generating, by the perception module, a point cloud from the plurality of sensor data slices when the plurality of sensor data slices satisfies the predetermined threshold;
generating, by the perception module, a multi-dimensional representation of a scanned scene from the point cloud; and
determining, by the perception module, one or more optimal positions within the scanned scene for an antenna associated with a wireless network from the multi-dimensional representation of the scanned scene using a trained neural network.

11. The method of claim 10, further comprising:
measuring, by the sensor device, individual sections of a scene that correspond to respective sets of point positions of the point cloud by emitting an optical signal pulse along the second direction in each of the individual sections of the scene;
detecting a returning optical signal pulse reflected from an object within at least one of the individual sections of the scene; and
determining a distance to the object based on a time delay between the optical signal pulse at time of emission and the returning optical signal pulse at time of reception, wherein the distance corresponds to a point position in the point cloud.

12. The method of claim 10, wherein the obtaining the sensor data comprises:
acquiring a first returning optical signal pulse at a first position along the first direction that represents a first time slice of sensor data and a second returning optical signal pulse at a second position along the first direction that represents a second time slice of sensor data, wherein each of the first time slice of sensor data and the second time slice of sensor data includes detected reflective objects of the scanned scene within a range of scanning angles along the second direction.

13. The method of claim 10, further comprising:
providing, by the perception module, a scanner control signal comprising one or more scanning parameters to the sensor device; and
adjusting, by the sensor device, one or more of a range of scanning angles along the second direction, a number of light pulses for emission by the sensor device, or an intensity of the light pulses, based on the one or more scanning parameters.

14. The method of claim 10, wherein a position of the mobile platform is adjusted from a first location to a second location along the first direction for at least in part a duration of the obtaining of the plurality of sensor data slices.

15. The method of claim 10, wherein each of the plurality of sensor data slices corresponds to a different position of the sensor device along the first direction.

16. The method of claim 10, wherein the predetermined threshold corresponds to a number of scanned scene slices used to combine together and form the point cloud of the scanned scene.

17. A non-transitory computer-readable medium having program code recorded thereon, the program code comprising:
code for causing a scanning system to obtain sensor data with a sensor device that is mounted on a mobile platform and rotated about a first direction, wherein the sensor data comprises a plurality of sensor data slices obtained by the sensor device over time along a second direction orthogonal to the first direction;
code for causing the scanning system to determine whether the plurality of sensor data slices satisfies a predetermined threshold;
code for causing the scanning system to generate a point cloud from the sensor data when the plurality of sensor data slices satisfies the predetermined threshold;
code for causing the scanning system to render a multi-dimensional representation of a scanned scene from the point cloud; and
code for causing the scanning system to determine one or more optimal positions within the scanned scene for an antenna associated with a wireless network from the multi-dimensional representation of the scanned scene using a trained neural network.

18. The non-transitory computer-readable medium of claim 17, wherein the program code further comprises:
code for causing the scanning system to encode the sensor data into the point cloud using a data pre-processing module.

19. The non-transitory computer-readable medium of claim 17, wherein the program code further comprises:
code for causing the scanning system to measure individual sections of a scene that correspond to respective sets of point positions of the point cloud by emitting an optical signal pulse along the second direction in each of the individual sections of the scene;
code for causing the scanning system to detect a returning optical signal pulse reflected from an object within at least one of the individual sections of the scene; and
code for causing the scanning system to determine a distance to the object based on a time delay between the optical signal pulse at time of emission and the returning optical signal pulse at time of reception, wherein the distance corresponds to a point position in the point cloud.

20. The non-transitory computer-readable medium of claim 17, wherein the program code further comprises:
code for causing the scanning system to acquire a first returning optical signal pulse at a first position along the first direction that represents a first time slice of sensor data and a second returning optical signal pulse at a second position along the first direction that represents a second time slice of sensor data, wherein each of the first time slice of sensor data and the second time slice of sensor data includes detected reflective objects of the scanned scene within a range of scanning angles along the second direction.
